(19) United States
(12) Patent Application Publication
(10) Pub. No.: US 2025/0024470 A1
(43) Pub. Date: Jan. 16, 2025

(54) METHOD AND DEVICE FOR PERFORMING SIDELINK COMMUNICATIONS

(71) Applicant: ZTE Corporation, Shenzhen (CN)

(72) Inventors: Wei LUO, Shenzhen (CN); Weiqiang DU, Shenzhen (CN); Lin CHEN, Shenzhen (CN)

(21) Appl. No.: 18/900,326

(22) Filed: Sep. 27, 2024

Related U.S. Application Data
(63) Continuation of application No. PCT/CN2022/122834, filed on Sep. 29, 2022.

(51) Int. Cl. H04W 72/25; H04W 72/0446; H04W 74/0808

(52) U.S. Cl. CPC H04W 72/25; H04W 72/0446; H04W 74/0808

(57) ABSTRACT

A wireless communication method for use in a first wireless terminal is disclosed. The method comprises determining a sidelink channel access priority for a sidelink transmission in an unlicensed carrier, and performing a listen-before-talk (LBT) procedure in the unlicensed carrier for the sidelink transmission based on the sidelink channel access priority.

### CROSS-REFERENCE TO RELATED APPLICATIONS

This application is a continuation of International Patent Application No. PCT/CN2022/122834, filed on Sep. 29, 2022, the disclosure of which is incorporated herein by reference in its entirety.

### TECHNICAL FIELD

This document is directed generally to wireless communications, in particular to 5th generation wireless communications, and in more particular to sidelink communications.

### BACKGROUND

Generally speaking, wireless communications are performed with user terminal devices and base stations. In addition, the wireless communications are performed on carriers or frequency bands. Some carriers are licensed carriers, which are carriers licensed by a governmental or other authoritative entity to a service provider for an exclusive use. On the other hands, other carriers are unlicensed carriers, which are carriers not licensed by such governmental or other authoritative entities. Currently, the user terminal devices may be able to communicate directly with each other (i.e., without use of a base station) on the licensed carriers. However, ways for the user terminal devices to communicate directly with each other on unlicensed carriers may be desirable.

### SUMMARY

The present disclosure is directed to methods, systems, and devices related to wireless communications, and more specifically, to methods, systems, and devices related to sidelink communications when performing a channel access on the unlicensed carrier (e.g., shared spectrum).

The present disclosure relates to a wireless communication method for use in a first wireless terminal. The method comprises:
determining a sidelink channel access priority for a sidelink transmission in an unlicensed carrier, and
performing a listen-before-talk (LBT) procedure in the unlicensed carrier for the sidelink transmission based on the sidelink channel access priority.

Various embodiments may preferably implement the following features:

Preferably, determining the sidelink channel access priority for the sidelink transmission in the unlicensed carrier comprises: determining the sidelink channel access priority for at least one of a sidelink media access control (MAC) control element (CE) or a sidelink MAC protocol data unit (PDU).

Preferably, the sidelink channel access priority is determined based on an indication,
wherein:
the first wireless terminal is in a connected state and the indication is received in a radio link control message,
the first wireless terminal is in an idle state and the indication is received in system information, or
the indication is preconfigured in the first wireless terminal.

Preferably, the indication includes a channel access priority class (CAPC) value of a MAC CE.

Preferably, the sidelink transmission comprises a sidelink transport block and the sidelink channel access priority is determined as:
a highest priority CAPC in response to the transport block including at least one of sidelink signaling radio bear (SRB), a sidelink broadcast control channel (SBCCH), or a sidelink MAC CE having the highest priority CAPC;
a lowest priority CAPC in response to the transport block including only at least one sidelink MAC CEs having the lowest priority CAPC,
a lowest priority CAPC of at least one sidelink data radio bearer (DRB) in the transport block in response to the transport block including only the at least one sidelink DRB; or
a lowest priority CAPC of at least one sidelink DRB and at least one MAC CE in the transport block in response to the transport block including only the at least one sidelink DRBs and the at least one sidelink MAC CE which do not have the fixed highest priority CAPC.

Preferably, the sidelink transmission comprises a sidelink transport block, and the sidelink channel access priority is determined as:
a highest priority CAPC of at least one logic channel in the MAC PDU, or
a lowest priority CAPC of at least one logic channel in the MAC PDU, or
an associated CAPC value to the priority of the sidelink transport block.

Preferably, the wireless communication method further comprises receiving, from the wireless network node, CAPC value for each priority value of the sidelink transport block.

Preferably, the wireless communication method further comprises transmitting, from a MAC entity to a physical layer entity of the first wireless terminal, information associated with the indicated CAPC of the sidelink transport block.

Preferably, the wireless communication method further comprises receiving, from a wireless network node, a table indication of a table used for performing the LBT procedure, or
(being) preconfigured with a table indication of a table used for performing the LBT procedure.

Preferably, the table indication indicates a table for at least one of each logic channel, each PC5 QoS profile, each PC5 QoS profile list or each sidelink resource pool.

Preferably, a table used for performing the LBT procedure is preconfigured.

Preferably, the table is a table of CAPC or a table of CAPC for uplink.

The present disclosure relates to a wireless communication method for used in a wireless network node. The method comprises:
transmitting, to a wireless terminal, a table indication of a table used for performing a listen-before-talk, LBT, procedure.

Various embodiments may preferably implement the following features:

Preferably, the table indication indicates a table for at least one of each logic channel, each PC5 QoS profile, each PC5 QoS profile list or each sidelink resource pool.

Preferably, the table is a table of CAPC or a table of CAPC for uplink.

The present disclosure relates to a wireless communication method for use in a wireless terminal. The method comprises:
performing a channel access procedure for a sidelink transmission in an unlicensed carrier based on an indication of a channel access procedure type.

Various embodiments may preferably implement the following features:

Preferably, the channel access procedure type indicates at least one of a Type 1 channel access procedure, a Type 2 channel access procedure or a semi-static channel occupancy channel access procedure.

Preferably, the wireless communication method further comprises receiving, from a wireless network node, the indication of the channel access procedure type.

Preferably, the indication is preconfigured in the wireless terminal.

The present disclosure relates to a wireless communication method for use in a wireless network node. The method comprises:
transmitting, to a wireless terminal, an indication of a channel access procedure type of a channel access procedure for a sidelink transmission in an unlicensed carrier.

Various embodiments may preferably implement the following feature:

Preferably, the channel access procedure type indicates at least one of a Type 1 channel access procedure, a Type 2 channel access procedure or a semi-static channel occupancy channel access procedure.

The present disclosure relates to a wireless communication method for use in a first wireless terminal. The method comprises:
receiving, from a second wireless terminal, a sidelink resource indication used for performing a sidelink transmission in an unlicensed carrier after a slot with an index n, and
performing the sidelink transmission in the unlicensed carrier after the slot with the index n based on the sidelink resource indication.

Various embodiments may preferably implement the following features:

Preferably, the sidelink resource indication comprises a channel occupancy time sharing indication received at the slot with the index n and a time offset X, and the sidelink transmission in the unlicensed carrier is performed no earlier than a slot with an index n+X.

Preferably, the sidelink resource indication comprises a sidelink offset/and a sidelink duration d for the slot n, and the sidelink transmission in the unlicensed carrier is performed no earlier than a slot with an index n+l+i, where i=0, 1, . . . , d−1.

Preferably, the wireless communication method further comprises transmitting, to the second wireless terminal, a channel occupancy time request,
wherein the channel occupancy time request comprises information associated with at least one of:
   a traffic periodicity of the sidelink transmission,
   a duration of the sidelink transmission,
   a number of resource blocks in the sidelink transmission,
   a number of sub-bands for the sidelink transmission,
   a minimum timing offset indicating an earliest timing of performing the sidelink transmission,
   a maximum timing offset indicating a last timing of performing the sidelink transmission, or
   a channel access priority of the sidelink transmission.

Preferably, the sidelink resource is associated with a priority threshold and a sidelink grant, and a priority value of data in the sidelink transmission is smaller than or equal to the priority threshold for the associated sidelink grant.

Preferably, the sidelink resource is associated with a destination id identifier and a sidelink grant, and a receiver of the sidelink transmission is associated with the associated destination id identifier for the associated sidelink grant.

The present disclosure relates to a wireless communication method for use in a second wireless terminal. The method comprises:
transmitting, to a first wireless terminal, a sidelink resource indication used for allowing the first wireless terminal to perform a sidelink transmission in an unlicensed carrier after a slot with an index n.

Various embodiments may preferably implement the following features:

Preferably, the sidelink resource indication comprises a channel occupancy time sharing indication received at the slot with the index n and a time offset X, and the sidelink transmission in the unlicensed carrier is performed no earlier than a slot with an index n+X.

Preferably, the sidelink resource indication comprises a sidelink offset/and a sidelink duration d for the slot n, and the sidelink transmission in the unlicensed carrier is performed no earlier than a slot with an index n+l+i, where i=0, 1, . . . , d−1.

Preferably, the wireless communication method further comprises receiving, from the first wireless terminal, a channel occupancy time request, wherein the channel occupancy time request comprises information associated with at least one of:
a traffic periodicity of the sidelink transmission,
a duration of the sidelink transmission,
a number of resource blocks in the sidelink transmission,
a number of sub-bands for the sidelink transmission,
a minimum timing offset indicating an earliest timing of performing the sidelink transmission,
a maximum timing offset indicating a last timing of performing the sidelink transmission, or
a channel access priority of the sidelink transmission.

Preferably, the sidelink resource is associated with a priority threshold and a sidelink grant, and a priority value of data in the sidelink transmission is smaller than or equal to the priority threshold for the associated sidelink grant.

Preferably, the sidelink resource is associated with a destination id identifier and a sidelink grant, and a receiver of the sidelink transmission is associated with the associated destination id identifier for the associated sidelink grant.

The present disclosure relates to a wireless communication method for use in a first wireless terminal. The method comprises:
performing a listen-before-talk (LBT) procedure in an unlicensed carrier for a sidelink transmission,
determining a result of the LBT procedure;
in response to determining that the result is an LBT success, transmitting, to a second wireless terminal, a sidelink signal on a channel in the unlicensed carrier, and
in response to determining that the result is an LBT failure, sending, from a physical layer entity of the first wireless terminal to a medium access control (MAC) layer entity of the first user device, an LBT failure indication.

Various embodiments may preferably implement the following features:

Preferably, in response to receiving the LBT failure indication by the MAC layer entity from the physical layer entity for the most recent transmission resource configured by the sidelink grant for a physical uplink control channel.

Preferably, the method further comprises: transmitting, to a wireless network node, a negative acknowledgement message in the physical uplink control channel.

Preferably, in response to receiving the LBT failure indication by the MAC entity from the physical layer entity, the method further comprises at least one of:
triggering a resource re-selection,
removing the at least one resource from a resource pool used by the resource re-selection,
dropping the at least one resource from at least one selected resource acquired by the resource re-selection, or
selecting at least one random resource from resources indicated by a physical layer entity and replacing the removed or dropped resources by the at least one random resource.

The present disclosure relates to a wireless communication method for use in a wireless terminal. The method comprises:
determining a plurality of physical sidelink feedback channel, PSFCH, reception occasions for a physical sidelink shared channel (PSSCH),
performing a hybrid automatic repeat request (HARQ) based sidelink radio link failure, RLF, detection on the plurality of PSFCH reception occasions, to determine a number associated with consecutive failed receptions on the plurality of PSFCH reception occasions, and

performing an operation in response to the number of consecutive failed transmissions on the plurality of PSFCH reception occasions reaches a threshold.

Various embodiments may preferably implement the following features:

Preferably, performing the HARQ based sidelink radio link failure detection on the plurality of PSFCH reception occasions, to determine the number associate with the consecutive failed transmissions on the plurality of PSFCH reception occasions comprises:
increasing the number by 1, wherein all receptions on the plurality of PSFCH reception occasions for the PSSCH are absent, and
setting the number to 0, wherein at least one reception on the plurality of PSFCH reception occasions for the PSSCH successes.

Preferably, the number of consecutive failed transmissions on the plurality of PSFCH reception occasions reaches a threshold, and the operation comprises at least one of:
indicating a HARQ-based sidelink RLF detection to a radio resource control layer entity,
determining that a sidelink RLF is detected for a destination wireless terminal of the PSSCH transmission,
releasing at least one data resource bearer of the destination wireless terminal,
releasing at least one signaling resource bearer of the destination wireless terminal,
releasing at least one PC5 Relay radio link control, RLC, channel of the destination wireless terminal,
discarding a new radio sidelink communication related configuration of the destination wireless terminal,
resetting a sidelink specific MAC layer entity of the destination wireless terminal, or
determining that a PC5 radio resource control connection is released for the destination wireless terminal.

The present disclosure relates to a first wireless terminal, comprising:
a processor, configured to:
determine a sidelink channel access priority for a sidelink transmission in an unlicensed carrier, and
perform a listen-before-talk (LBT) procedure in the unlicensed carrier for the sidelink transmission based on the sidelink channel access priority.

Various embodiments may preferably implement the following feature:

Preferably, the processor is further configured to perform any of the aforementioned wireless communication methods.

The present disclosure relates to a wireless network node, comprising:
a communication unit, configured to transmitting, to a wireless terminal, a table indication of a table used for performing a listen-before-talk (LBT) procedure.

Various embodiments may preferably implement the following feature:

Preferably, the wireless network node further comprises a processor configured to perform any of the aforementioned wireless communication methods.

The present disclosure relates to a wireless terminal, comprising:
a processor, configured to perform a channel access procedure for a sidelink transmission in an unlicensed carrier based on an indication of a channel access procedure type.

Various embodiments may preferably implement the following feature:

Preferably, the processor is further configured to perform any of the aforementioned wireless communication methods.

The present disclosure relates to a wireless network node, comprising:
a communication unit, configured to transmit, to a wireless terminal, an indication of a channel access procedure type of a channel access procedure for a sidelink transmission in an unlicensed carrier.

Various embodiments may preferably implement the following feature:

Preferably, the wireless network node further comprises a processor configured to perform any of the aforementioned wireless communication methods.
first wireless terminal, comprising:
The present disclosure relates to a communication unit, configured to receive, from a second wireless terminal, a sidelink resource indication used for performing a sidelink transmission in an unlicensed carrier after a slot with an index n, and
a processor, configured to perform the sidelink transmission in the unlicensed carrier after the slot with the index n based on the sidelink resource indication.

Various embodiments may preferably implement the following feature:

Preferably, the processor is further configured to perform any of the aforementioned wireless communication methods.

The present disclosure relates to a second wireless terminal, comprising:
a communication unit, configured to transmit, to a first wireless terminal, a sidelink resource indication used for allowing the first wireless terminal to perform a sidelink transmission in an unlicensed carrier after a slot with an index n.

Various embodiments may preferably implement the following feature:

Preferably, the second wireless terminal further comprises a processor configured to perform any of the aforementioned wireless communication methods.

The present disclosure relates to a first wireless terminal, comprising:
a processor, configured to:
perform a listen-before-talk (LBT) procedure in an unlicensed carrier for a sidelink transmission, determine a result of the LBT procedure;
in response to determining that the result is an LBT success, transmit, to a second wireless terminal, a sidelink signal on a channel in the unlicensed carrier, and
in response to determining that the result is an LBT failure, send, from a physical layer entity of the first wireless terminal to a medium access control (MAC) layer entity of the first user device, an LBT failure indication.

Various embodiments may preferably implement the following feature:

Preferably, the processor is further configured to perform any of the aforementioned wireless communication methods.

The present disclosure relates to a wireless terminal, comprising:
a processor, configured to:
determine a plurality of physical sidelink feedback channel, PSFCH, reception occasions for a physical sidelink shared channel, PSSCH,
perform a hybrid automatic repeat request, HARQ, based sidelink radio link failure, RLF, detection on the plurality of PSFCH reception occasions, to determine a number associated with consecutive failed receptions on the plurality of PSFCH reception occasions, and
perform an operation in response to the number of consecutive failed transmissions on the plurality of PSFCH reception occasions reaches a threshold.

Various embodiments may preferably implement the following feature:

Preferably, the processor is further configured to perform any of the aforementioned wireless communication methods.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of a wireless communication system according to an embodiment of the present disclosure.

FIG. 2 shows a schematic diagram of a configuration of layer entities for a communication node according to an embodiment of the present disclosure.

FIG. 3 shows a flow chart of method for wireless communication that includes detecting for listen-before-talk (LBT) failures according to an embodiment of the present disclosure.

FIGS. 4 to 6 show schematic diagrams of sidelink communication according to embodiments of the present disclosure.

### DETAILED DESCRIPTION

The present description describes various embodiments of systems, apparatuses, devices, and methods for wireless communications involving sidelink transmissions, including those in unlicensed carriers.

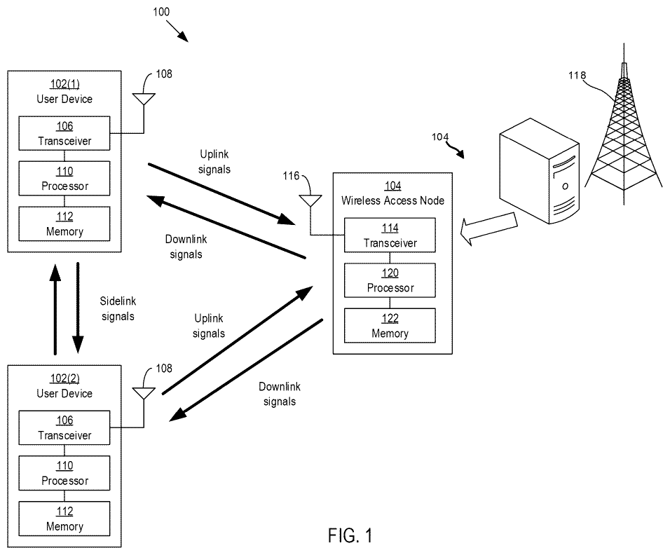

FIG. 1 shows a diagram of an example wireless communication system 100 including a plurality of communication nodes (or just nodes) that are configured to wirelessly communicate with each other. In general, the communication nodes include at least one user device 102 and at least one wireless access node 104. The example wireless communication system 100 in FIG. 1 is shown as including two user devices 102, including a first user device 102(1) and a second user device 102(2), and one wireless access nodes 104. However, various other examples of the wireless communication system 100 that include any of various combinations of user devices 102 and wireless access nodes 104, including two or more user devices 102 without any wireless access nodes 104, only one user device 102 and only one wireless access node 104, only one user device 102 and two or more wireless access nodes 104, two or more user devices 102 and one or more wireless access nodes 104, or two or more wireless access nodes 104 without any user devices 102.

In general, a user device as described herein, such as the user devices 102, may include a single electronic device or apparatus, or multiple (e.g., a network of) electronic devices or apparatuses, capable of communicating wirelessly over a network. A user device may comprise or otherwise be referred to as a user terminal, a user terminal device, or a user equipment (UE). Additionally, a user device may be or include, but not limited to, a mobile device (such as a mobile phone, a smart phone, a smart watch, a tablet, a laptop computer, vehicle or other vessel (human, motor, or engine-powered, such as an automobile, a plane, a train, a ship, or a bicycle as non-limiting examples) or a fixed or stationary device, (such as a desktop computer or other computing device that is not ordinarily moved for long periods of time, such as appliances, other relatively heavy devices including Internet of things (IoT), or computing devices used in commercial or industrial environments, as non-limiting examples). In various embodiments, a user device 102 may include transceiver circuitry 106 coupled to an antenna 108 to effect wireless communication with the wireless access node 104. The transceiver circuitry 106 may also be coupled to a processor 110, which may also be coupled to a memory 112 or other storage device. The memory 112 may store therein instructions or code that, when read and executed by the processor 110, cause the processor 110 to implement various ones of the methods described herein.

Additionally, in general, a wireless access node as described herein, such as the wireless access node 104, may include a single electronic device or apparatus, or multiple (e.g., a network of) electronic devices or apparatuses, and may comprise one or more base stations or other wireless network access points capable of communicating wirelessly over a network with one or more user devices and/or with one or more other wireless access nodes 104. For example, the wireless access node 104 may comprise a 4G LTE base station, a 5G NR base station, a 5G central-unit base station, a 5G distributed-unit base station, a next generation Node B (gNB), an enhanced Node B (eNB), or other similar or next-generation (e.g., 6G) base stations, in various embodiments. A wireless access node 104 may include transceiver circuitry 114 coupled to an antenna 116, which may include an antenna tower 118 in various approaches, to effect wireless communication with the user device 102 or another wireless access node 104. The transceiver circuitry 114 may also be coupled to one or more processors 120, which may also be coupled to a memory 122 or other storage device. The memory 122 may store therein instructions or code that, when read and executed by the processor 120, cause the processor 120 to implement one or more of the methods described herein.

In various embodiments, two communication nodes in the wireless system 100, such as a user device 102 and a wireless access node 104, two user devices 102 without a wireless access node 104, or two wireless access nodes 104 without a user device 102, may be configured to wirelessly communicate with each other in or over a mobile network and/or a wireless access network according to one or more standards and/or specifications. In general, the standards and/or specifications may define the rules or procedures under which the communication nodes can wirelessly communicate, which, in various embodiments, may include those for communicating in millimeter (mm)-Wave bands, and/or with multi-antenna schemes and beamforming functions. In addition or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

Additionally, in various embodiments, two or more of the communication nodes in the wireless system 100, may be configured to communicate according to vehicle networking standards and/or specifications. As used herein, vehicle networking refers to a large-scale system for wireless communication and information exchange involving a vehicle, pedestrians, roadside equipment and the Internet in accordance with any of various communication protocols and data exchange standards. Vehicle networking communications may enhance vehicle performance with respect to driving safety, traffic efficiency, usability or user convenience features, or entertainment. Additionally, in any of various embodiments, vehicle networking communication may be categorized into three types: communication between vehicles (also called vehicle-to-vehicle (V2V)); communication between a vehicle and roadside equipment/network infrastructure (called vehicle-to-infrastructure/vehicle-to-network (V2I/V2N)); and communication between vehicles and pedestrians (called vehicle-to-pedestrian (V2P)). These types of communications are collectively referred to as vehicle-to-everything (V2X) communication. Communication nodes participating in V2X communicates may communicate with each other according to any of various V2X standards or specifications.

In the wireless system 100, the communication nodes are configured to wirelessly communicate signals between each other. In general, a communication in the wireless system 100 between two communication nodes can be or include a transmission or a reception, and is generally both simultaneously, depending on the perspective of a particular node in the communication. For example, for a given communication between a first node and a second node where the first node is transmitting a signal to the second node and the second node is receiving the signal from the first node, the first node may be referred to as a source or transmitting node or device, the second node may be referred to as a destination or receiving node or device, and the communication may be considered a transmission for the first node and a reception for the second node. Of course, since communication nodes in a wireless system 100 can both send and receive signals, a single communication node may be both a transmitting/source node and a receiving/destination node simultaneously or switch between being a sending node and a receiving node.

Also, particular signals can be characterized or defined as either an uplink (UL) signal, a downlink (DL) signal, or a sidelink (SL) signal. An uplink signal is a signal transmitted from a user device 102 to a wireless access node 104. A downlink signal is a signal transmitted from a wireless access node 104 to a user device 102. A sidelink signal is a signal transmitted from a one user device 102 to another user device 102, or a signal transmitted from one wireless access node 104 to a another wireless access node 104. Also, for sidelink transmissions, a first/source user device 102 directly transmits a sidelink signal to a second/destination user device 102 without any forwarding of the sidelink signal to a wireless access node 104.

For at least some embodiments involving V2X communication, user devices 102 may perform sidelink transmissions. Such sidelink communications in V2X may be referred to as a PC5-based V2X communication or V2X communication. Additionally, for sidelink communications in V2X, user device 102 may communicate sidelink signals to each other using a PC5 interface, where PC5 refers to a reference point where a user device 102 communicates with another user device 102 over a direct channel.

As V2X technology advances, including in the automation industry, scenarios for V2X communications are being increasingly diversified and require higher performance. Examples of advanced V2X services include vehicle platooning, extended sensors, advanced driving (semi-automated driving and full-automated driving), and remote driving. Example performance requirements for these advanced V2X services may include: supporting data packets with a size of 50 to 12,000 bytes, a transmission rate of 2 to 50 messages per second, a maximum end-to-end delay of 3 to 500 milliseconds, a reliability of 90% to 99.999%, a date rate of 0.5 to 1,000 Megabytes per second (Mbps), or a transmission range of 50 to 1,000 meters, as non-limiting examples.

In addition, communication nodes using NR radio access operating with shared spectrum channel access may be configured to operate in different modes, where primary cells (PCells), primary secondary cells (PSCells) or secondary cells (SCells) can be in the shared spectrum, and an SCell may or may not be configured with uplink transmissions. Further, in both channel access modes, the wireless access node 104 and the user device 102 may be configured to apply or perform listen-before-talk (LBT) procedures before performing a transmission on a cell configured with shared spectrum channel access.

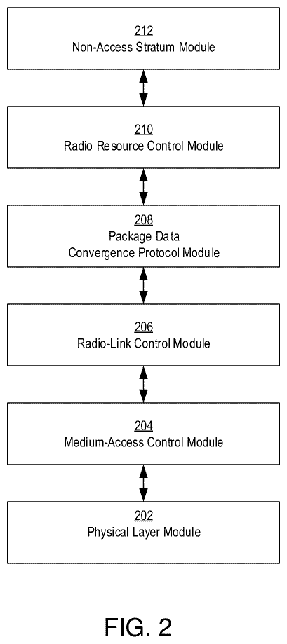

FIG. 2 shows a block diagram of a plurality of modules of a communication node (e.g., a user device 102 or a wireless access node 104), including a physical layer (PHY) entity or module (also called herein as just PHY layer, PHY module, or PHY entity) 202, a medium-access control (MAC) layer entity or module (also called herein as just MAC layer, MAC module, or MAC entity) 204, a radio-link control (RLC) layer entity or module (also called herein as just RLC layer, RLC entity, or RLC module) 206, a package data convergence protocol (PDCP) layer entity or module (also called herein as just PDCP layer, PDCP entity, or PDCP module) 208, a radio resource control (RRC) layer entity or module (also called herein as just RRC layer, RRC entity, or RRC module) 210, and a Non-Access Stratum (NAS) layer entity or module (also called herein as just NAS layer, NAS entity, or NAS module) 212.

In the present disclosure, as used herein unless expressed otherwise, the terms “layer”, “entity”, and “module”, used alone or in combination with each other, and as used for one or more components of a communication node, is an electronic device, such as electronic circuit, that includes hardware or a combination of hardware and software. In various embodiments, a module or an entity may be considered part of, or a component of, or implemented using one or more of the components of a communication node of FIG. 1, including a processor 110/120, a memory 112/122, a transceiver circuit 106/114, or the antenna 108/116. For example, the processor 110/120, such as when executing computer code stored in the memory 112/116, may perform the functions of a module or entity. Additionally, in various embodiments, the functions that a module or entity performs may be defined by one or more standards or protocols, such as 5G NR for example.

Additionally, the layer entities 202-212 in FIG. 2 may be higher and lower layers relative to each other, with the PHY layer entity 202 being the lowest layer among the layer entities 202-212; the MAC layer entity 204 being a higher layer than the PHY layer entity 202 and lower than the other layer entities 206-212; the RLC layer entity 206 being higher than the PHY and MAC layer entities 202, 204 and lower than the PDCP, RRC, and NAS layer entities 208-212; the PDCP layer entity 208 being higher than the PHY, MAC, and RRC layer entities 202-206 and lower than the RRC and NAS layer entities 210, 212; the RRC layer entity 210 being higher than the PHY, MAC, RRC, and PDCP layer entities 202-208 and lower than the NAS layer entity 212; and the NAS layer entity 212 being the highest layer entity among the layer entities 202-220 shown in FIG. 2. In various embodiments, a communication node of the system 100 may include modules and/or layer entities other than those shown in FIG. 2.

### CAPC Value

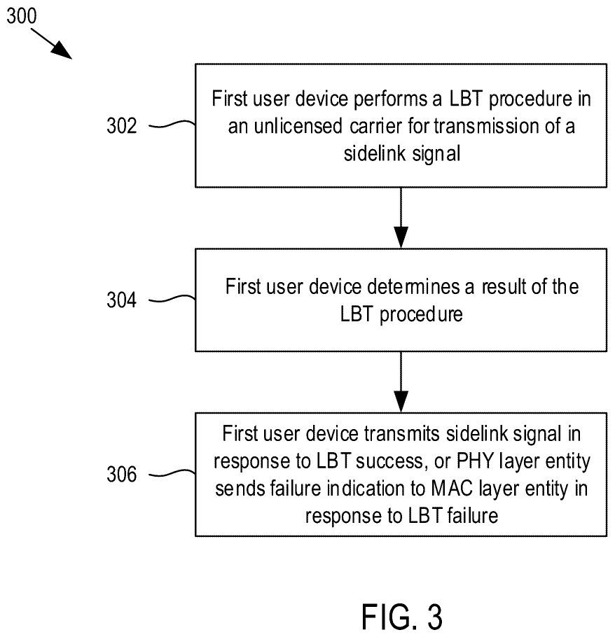

FIG. 3 shows a schematic diagram of a method 300 according to an embodiment of the present disclosure. The method 300 is for wireless communications that includes sidelink communications between the first user device 102(1) and the second user device 102(2) on an unlicensed carrier. The embodiments of the method 300 have the first user device 102(1) functioning as a source or transmitting user device that transmits a sidelink signal to the second user device 102(2), and the second user device 102(2) functioning as a destination or receiving user device that receives the sidelink signal from the first user device 102(1).

In the present disclosure, a licensed carrier is a carrier, frequency band or spectrum that is licensed by a government or other authoritative entity (e.g., the Federal Communications Commission (FCC) in the United States or the European Telecommunications Standards Institute (ETSI) in Europe) to a service provider for exclusive use. An unlicensed carrier, also called a shared spectrum, is a carrier, frequency band or spectrum that is not licensed by a government or other authoritative entity.

At block 302, the first user device 102(1) may perform a listen-before-talk (LBT) procedure in an unlicensed carrier for transmission of a sidelink signal. In general, when a user device 102 wants to transmit a signal (e.g., an uplink signal or a sidelink signal) on a channel in a particular carrier (unlicensed), the user device may perform an LBT procedure in the carrier before transmitting the signal. During an LBT procedure, the user device 102 may listen to or sense the channel to determine whether the channel is available (free) or busy. In response to, or as a result of, performing the LBT procedure, the user device 102 may determine whether the LBT procedure is a success or a failure. The success indicates that the channel is available, and in turn, the user device 102 can proceed to transmit the signal. The failure indicates that the channel is busy, and in turn, the user device 102 determines not to transmit the signal.

In various embodiments, at block 302, the first user device 102(1) may perform the LBT procedure according to a sidelink channel access priority. Specifically, during the LBT procedure, an amount of time that the first device 102 has to monitor the channel may depend on a value of the sidelink channel access priority. Also, in an event that the result of the LBT procedure is a success, an amount of time resources the channel occupies may depend on the value of the sidelink channel access priority.

In some of these embodiments, the sidelink channel access priority is a sidelink channel access priority of a sidelink logical channel. For example, the first user device 102(1) may be configured with a plurality of logical channels, and each logical channel may have or be mapped to an associated priority value for a sidelink channel access priority. The priority values may be the same as or different from each other for the different logical channels. Correspondingly, when the first user device 102(1) determines to transmit data (e.g., data of a MAC protocol data unit (PDU)) as part of the sidelink signal, the first user device 102(1) may determine a logical channel that corresponds to the data, and in turn, determine a priority value corresponding to the logical channel. The first user device 102(1) may then perform the LBT procedure according to the determined priority value.

In addition, for at least some embodiments, the data (e.g., of the MAC PDU) may correspond to multiple logical channels. Correspondingly, the first user device 102(1) may determine a plurality of priority values for the multiple logical channels, and then select a value corresponding to a highest priority value from among the plurality of priority values. In other embodiments, the first user device 102(1) may determine a plurality of priority values for the multiple logical channels, and then select a value corresponding to a lowest priority value from among the plurality of priority values.

In some embodiments, the sidelink channel access priority is a sidelink channel access priority of a quality of service (QOS) profile. The QoS profile may identify a set of QoS parameters corresponding to data to be transmitted, such as a sidelink PC5 QoS Identifier (PQI), a sidelink guaranteed flow bit rate (GFBR), a sidelink maximum flow bit rate (MFBR), and/or a sidelink range. For such embodiments, the first user device 102(1) may identify a QoS profile corresponding to data to be transmitted in the sidelink transmission.

In turn, the first user device 102(1) may identify a priority value corresponding to the QoS profile. Additionally, for at least some embodiments, the data (e.g., of the MAC PDU) may correspond to multiple PC5 QoS profile. Correspondingly, the first user device 102(1) may determine a plurality of priority values for the multiple QoS profile, and then select a value corresponding to a highest priority value from among the plurality of priority values. In other embodiments, the first user device 102(1) may determine a plurality of priority values for the multiple QoS profile, and then select a value corresponding to a lowest priority value from among the plurality of priority values. The first user device 102(1) may then perform the LBT procedure according to the determined priority value.

In addition or alternatively, the first user device 102(1) may receive the sidelink channel access priority for each logical channel or each PC5 QoS profile or PC5 QoS profile list or SL IUC (inter-UE coordination information) related MAC CE via a RRC message in response to the first user device 102(1) being in a RRC connected state; may receive the sidelink channel access priority for each logical channel or each PC5 QoS profile or PC5 QoS profile list or SL IUC (inter-UE coordination information) related MAC CE via system information in response to the first user device 102(1) being in RRC idle; and/or may be preconfigured with the sidelink channel access priority for each logical channel or each PC5 QoS profile or PC5 QoS profile list or SL IUC (inter-UE coordination information) related MAC CE in response to the UE being out of coverage.

In addition or alternatively, in various embodiments, the first user device 102(1) may use channel access priority classes (CAPCs) of radio bearers (RBs) and MAC control elements (CEs) for priority values for LBT procedures. In some embodiments, the CAPCs of RBs and MAC CEs are either fixed or configurable. For example, the CAPCs may be fixed to the highest priority for sidelink signaling radio bearers (SRBs) and one or more sidelink MAC CEs; configured by the network (wireless access node 104) for sidelink data radio bearers (DRB); or fixed to a lowest priority for other sidelink MAC CEs. When choosing a CAPC of a given DRB, the wireless access node 104 may take into account PQIs of all of the QoS flows multiplexed in the given DRB while considering fairness between different traffic types and transmissions. The communication nodes in the system 100 may use the CAPC of a standardized PQI that best matches QoS characteristics of a non-standardized PQI for a QoS flow corresponding to the non-standardized PQI.

In addition or alternatively, in various embodiments, the first user device 102(1) may select a CAPC as the priority for the LBT procedure by selecting: the highest priority CAPC of a sidelink DRB in response to a transport block (TB) of the sidelink signal to be transmitted including multiple sidelink DRBs; selecting a highest priority CAPC in response to the transport block including at least one sidelink SRB, a sidelink broadcast control channel (SBCCH), or a sidelink MAC CE having the highest priority CAPC; or selecting a lowest priority CAPC in response to the transport block only including one or more sidelink MAC CEs having the lowest priority CAPC, or selecting the lowest priority CAPC of a sidelink DRB in response to a transport block (TB) of the sidelink signal to be transmitted only including sidelink DRBs; or selecting the lowest priority CAPC of a sidelink DRB in response to a transport block (TB) of the sidelink signal to be transmitted only including sidelink DRBs and one or more sidelink MAC CEs having the lowest priority CAPC.

In addition or alternatively, in various embodiments, if a MAC PDU to transmit has been obtained, the MAC layer entities 204 of the first user device 102(1) may determines the CAPC value of the TB for the source and destination pair of the MAC PDU. In an embodiment, the MAC layer entities 204 may set the CAPC value to the value of the highest priority of the logical channel(s) (if include) and a MAC CE (if included) in the MAC PDU. In an embodiments, the MAC layer entities 204 may set the CAPC value to the value of the lowest priority of the logical channel(s) if no sidelink MAC CE and/or sidelink SRB is included in the MAC PDU. Then the MAC layer entities 204 indicate the CAPC value to the PHY layer entities 202. The PHY layer entities 202 may perform the LBT procedure according to the CAPC priority value.

In addition or alternatively, the first user device 102(1) may receive the sidelink channel access priority for each priority of MAC PDU via an RRC message in response to the first user device 102(1) being in a RRC connected state; may receive the sidelink channel access priority for each priority of MAC PDU via system information in response to the first user device 102(1) being in RRC idle; and/or may be preconfigured with the sidelink channel access priority for each priority of MAC PDU in response to the UE being out of coverage.

In some embodiments, if the MAC PDU to be transmitted has been obtained, the MAC layer entities 204 of the first user device 102(1) determines the priority value of the TB for the source and destination pair of the MAC PDU. In an embodiment, the MAC layer entities 204 indicate the priority value of the MAC PDU to the PHY layer entities 202. The PHY layer entities 202 determine the CAPC value according to the indicated priority value of the MAC PDU and the information of sidelink channel access priority for each priority of MAC PDU. The PHY layer entities 202 may then perform the LBT procedure according to the determined priority value.

In an embodiment, the MAC layer entities 204 determine the priority value of the MAC PDU, and then determine the CAPC value according to the priority value of the MAC PDU and the information of sidelink channel access priority for each priority of MAC PDU, then indicate the determined CAPC value to the PHY layer entities 202. The PHY layer entities 202 may then perform the LBT procedure according to the indicated priority value.

In an embodiment, a method for wireless communication is disclosed. The method comprises:
performing, with a first user device, an LBT procedure in an unlicensed carrier for a sidelink transmission;
determining, with the first user device, a result of the LBT procedure;
in response to determining that the result is an LBT success, transmitting, with the first user device, a sidelink signal on a channel in the unlicensed carrier to a second user device; and
in response to determining that the result is an LBT failure, sending, with a physical layer entity of the first user device, an LBT failure indication to a medium access control (MAC) layer entity of the first user device.

In this embodiment, performing the LBT procedure in the unlicensed carrier may further comprise: acquiring, with the first user device, a sidelink channel access priority for a sidelink MAC CE or a SL MAC PDU priority.

In an embodiment, the sidelink signal comprises a sidelink transport block and the method may further comprises:
selecting, with the first user device, a channel access priority class (CAPC) for the LBT procedure, wherein the selecting comprises one of:
selecting a highest priority CAPC in response to the transport block including at least one sidelink SRB, a sidelink broadcast control channel (SBCCH), or a sidelink MAC CE having the highest priority CAPC; or
selecting a lowest priority CAPC in response to the transport block only including one or more sidelink MAC CEs having the lowest priority CAPC, or
selecting the lowest priority CAPC of a sidelink DRB in response to a transport block (TB) of the sidelink signal to be transmitted only including sidelink DRBs; or selecting the lowest priority CAPC of a sidelink DRB and MAC CEs in response to a transport block (TB) of the sidelink signal to be transmitted only including sidelink DRBs and one or more sidelink MAC CEs not having the highest priority CAPC.

### CAPC Table

A UE may transmit the sidelink transmission using Type 1 channel access procedure after first sensing the channel to be idle during the slot durations of a defer duration T_{d}, and after the counter N is zero in step 4. The counter N is adjusted by sensing the channel for additional slot duration(s) according to the steps described below.
1) set N=Nᵢₙᵢₜ, where Nᵢₙᵢₜ is a random number uniformly distributed between 0 and CWₚ, and go to step 4;
2) if N>0 and the UE chooses to decrement the counter, set N=N−1;
3) sense the channel for an additional slot duration, and if the additional slot duration is idle, go to step 4; else, go to step 5;
4) if N=0, stop; else, go to step 2.
5) sense the channel until either a busy slot is detected within an additional defer duration T_{d} or all the slots of the additional defer duration T_{d} are detected to be idle;
6) if the channel is sensed to be idle during all the slot durations of the additional defer duration T_{d}, go to step 4; else, go to step 5;
   wherein, the parameter of mₚ, CW_{min,p}, and CW_{max,p} are based on a channel access priority class p as shown in the following Table 1 or Table 2.

TABLE 1
Channel Access Priority Class (CAPC)

| Channel | | | | | |
|---|---|---|---|---|---|
| Access | | | | | |
| Priority | | | | | |
| Class (p) | mₚ | CW_{min,p} | CW_{max,p} | T_{m cot,p} | allowed CWₚ sizes |
| 1 | 1 | 3 | 7 | 2 ms | {3, 7} |
| 2 | 1 | 7 | 15 | 3 ms | {7, 15} |
| 3 | 3 | 15 | 63 | 8 or 10 ms | {15, 31, 63} |
| 4 | 7 | 15 | 1023 | 8 or 10 ms | {15, 31, 63, 127, |
| | | | | | 255, 511, 1023} |

For p=3 and p=4, if the absence of any other technology sharing the channel can be guaranteed on a long term basis (e.g. by level of regulation), T_{m cot,p}=10 ms, otherwise, T_{m cot,p}=8 ms.

TABLE 2
Channel Access Priority Class (CAPC) for UL

| Channel | | | | | |
|---|---|---|---|---|---|
| Access | | | | | |
| Priority | | | | | |
| Class (p) | mₚ | CW_{min,p} | CW_{max,p} | T_{ulm cot,p} | allowed CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or | {15, 31, 63, 127, |
| | | | | 10 ms | 255, 511, 1023} |
| 4 | 7 | 15 | 1023 | 6 ms or | {15, 31, 63, 127, |
| | | | | 10 ms | 255, 511, 1023} |

NOTE1:
For p = 3, 4, T_{ulm cot,p} = 10 ms if the higher layer parameter absenceOfAnyOtherTechnology-r14 or absenceOfAnyOtherTechnology-r16 is provided, otherwise, T_{ulm cot,p} = 6 ms.
NOTE 2:
When T_{ulm cot,p} = 6 ms it may be increased to 8ₘₛ by inserting one or more gaps. The minimum duration of a gap shall be 100ᵤₛ. The maximum duration before including any such gap shall be 6 ms.

If Table 1 is used, the UE may share longer duration COTs. If Table 2 is used, the UE may use a wider range of CWs to offer more chances to back off if collisions occur, which means that more channel access opportunities can be acquired. However, the UE needs to determine which table is used when using Type 1 channel access procedure. For one embodiment, the UE can acquire the indication information of which table is used for Type 1 channel access procedure from the network when it is in coverage. For another embodiment, the UE can be preconfigured the indication information of which table is used for Type 1 channel access procedure when it is out of coverage. For another embodiment, the first user device 102(1) may receive the sidelink channel access priority and/or indication information of which table is used for Type 1 channel access procedure for each logical channel or each PC5 QoS profile or PC5 QoS profile list via a RRC message in response to the first user device 102(1) being in a RRC connected state; may receive the sidelink channel access priority and/or indication information of which table is used for Type 1 channel access procedure for each logical channel or each PC5 QoS profile or PC5 QoS profile list via system information in response to the first user device 102(1) being in RRC idle; and/or may be preconfigured with the sidelink channel access priority and/or indication information of which table is used for Type 1 channel access procedure for each logical channel or each PC5 QoS profile or PC5 QoS profile list in response to the UE being out of coverage.

### Channel Access Scheme

In some embodiments, the UE may transmit the sidelink transmission using Type 1 channel access procedure or using a semi-static channel occupancy channel access procedure. For example, the semi-static channel occupancy channel access procedure may be that defined in TS37.213: Technical Specification Group Radio Access Network; Physical layer procedures for shared spectrum channel access. If different UEs use different channel access procedures, it may be unfair to each other and the collision probability may also increase. In fact, the channel access procedures based on semi-static channel occupancy are intended for environments where the absence of other technologies is guaranteed. Consider that the UE may transmit the sidelink transmission in different sidelink RB sets (contiguous set of resource blocks) or in different sidelink resource pools or sidelink unlicensed carrier, the network provides UE indication of whether the semi-static channel occupancy channel access procedure is used. To be specific, the network provides UE indication of whether the semi-static channel occupancy channel access procedure is used for each sidelink RB set or sidelink resource pool or sidelink unlicensed carrier.

### COT (Channel Occupancy Time)

For the out of coverage (OOC) UE, the UE may be pre-configured with indication of whether the semi-static channel occupancy channel access procedure is used. To be specific, the UE may be pre-configured with indication of whether the semi-static channel occupancy channel access procedure is used for each sidelink RB set or sidelink resource pool or sidelink unlicensed carrier. Then the UE can perform channel access procedure based on the configuration.

If a UE is indicated to perform Type 2 channel access procedures, the UE uses Type 2 channel access procedures for a sidelink transmission. The UE may transmit the transmission immediately after sensing the channel to be idle for at least a sensing interval. The sensing interval maybe 0, 16 μs, 25 μs or other value.

When a first UE shares a COT initiated by a second UE, the first UE may transmit a sidelink transmission that follows a sidelink transmission by the second UE.

In an embodiment, the COT may be shared based on the steps below.
Step 1: The second UE sends ‘COT sharing indication’ and ‘X’ in SCI (sidelink control information) in slot/subframe n to the first UE;
Step 2: The first UE may transmit a sidelink transmission in slot/subframe n+X.

In another embodiment, the COT may be shared based on the steps below:
Step 1: The second UE sends ‘SL duration and offset’ field indicating an ‘SL offset’ l and an ‘SL duration’ d for slot/subframe n to a first UE;
Step 2: a first UE may use channel access procedures Type 2 for sidelink transmissions in slot/subframe n+l+i where i=0, 1, . . . , d−1.

In order to avoid wasting resources and improve the resource utilization, the first UE may send a COT request to the second UE before the above step 1. In an embodiment, the COT request includes at least one of:

trafficPeriodicity ENUMERATED {{ms20, ms50, ms100,
ms200, ms300, ms400, ms500, ms600, ms700, ms800, ms900, ms1000} ,
duration INTEGER (1..39),
MintimingOffset INTEGER (1..39),
MaxtimingOffset INTEGER (1..39),
RBNum OR SubbandNum
channelAccessPriority INTEGER (1..4)

wherein the above parameters may be defined as:
trafficPeriodicity indicates an estimated data arrival periodicity. The trafficPeriodicity may have a value ms20 corresponding to 20 ms, a value corresponds to 50 ms and so on;
Duration indicates an estimated data arrival duration;
RBNum indicates the maximum number of RBs based on an observed traffic pattern;
SubbandNum indicates the maximum number of sub-bands based on an observed traffic pattern.
MintimingOffset indicates the minimum estimated timing for a packet arrival.
MaxtimingOffset indicates the maximum estimated timing for a packet arrival.
channelAccessPriority indicates the channel Access Priority of an estimated data arrival.

In an embodiment, the COT request may include multiple sets of above parameters.

### LCP (Logical Channel Prioritization)

In some embodiments, a first UE may share a COT initiated by a second UE or by the network (e.g., gNB). For example, the second UE or the gNB may provide a sidelink grant with a priority value P to the first UE.

When the first UE acquires a sidelink grant, the first UE may perform a sidelink Logical Channel Prioritization procedure to obtain the MAC PDU to transmit. During the sidelink Logical Channel Prioritization procedure, the UE needs to determine which destination ID (identifier) shall be selected. The first UE may further determine which logical channels can be selected for the selected destination ID.

In an embodiment of the sidelink grant being associated with the priority value P and the UE acquiring the sidelink channel access priority for each logical channel, the UE may select the logical channels of which CAPC value is not larger than the value P when performing sidelink the Logical Channel Prioritization procedure.

In an embodiment of the sidelink grant being associated to a destination ID, the UE may only select the destination ID associated to the sidelink grant when performing the sidelink Logical Channel Prioritization procedure.

### Resource Allocation

In some embodiment, for performing the sidelink communications, the UE may use mode 1 and/or mode 2 resource allocation mechanism to transmit sidelink data. For mode 2 resource allocation mechanism, the transmission resource is selected by the UE itself within a configured resource pool. For the mode 1 resource allocation mechanism, the transmission resource is scheduled by the network. When the mode 1 resource allocation mechanism is used, the network may schedule more than one transmission resource in DCI (downlink control information) via a PDCCH (physical downlink control channel). If the UE does not complete the transmission (e.g., does not receive HARQ ACK (hybrid automatic repeat request acknowledgement) information from a peer UE) or considers more re-transmissions are needed, the UE may send a HARQ NACK to the network for requesting more transmission resources.

In an embodiment of the sidelink UE performing the mode 2 resource allocation mechanism, the sidelink UE can select the resource for transmission in a configured resource pool. When the UE performing the resource selection in unlicensed band, the UE may perform LBT procedure before using the selected resource to transmit the sidelink data. If the result of the LBT procedure indicates a success, the UE can use the selected resource to transmit the sidelink data. When the result of the LBT procedure indicates a failure (i.e., the selected resource cannot be used to continue transmitting the data), the UE may re-select another resource immediately and the original selected resource may be removed or dropped. In an embodiment, a type2 (2a, 2b or 2c) LBT procedure may be used to decrease the latency for the re-selected resource.

In an embodiment, if an LBT failure (i.e., the result of the LBT procedure indicating a failure) is detected on one selected sidelink resource, the UE performs at least one of:
1. triggering resource re-selection;
2. removing the LBT failure resource(s) from the selected sidelink resource;
3. dropping the LBT failure resource(s) from the selected sidelink resource; or
4. randomly selecting a resource from the resources indicated by the physical layer and replace the removed or dropped resource(s) by the selected resource(s).

In an embodiment, the UE is allowed to perform at least one of following types of LBT procedure for the resource which is used to replace the removed or dropped resource:
1. type1 LBT procedure;
2. type2 LBT procedure;
3. type2a LBT procedure;
4. type2b LBT procedure; or
5. type2c LBT procedure.

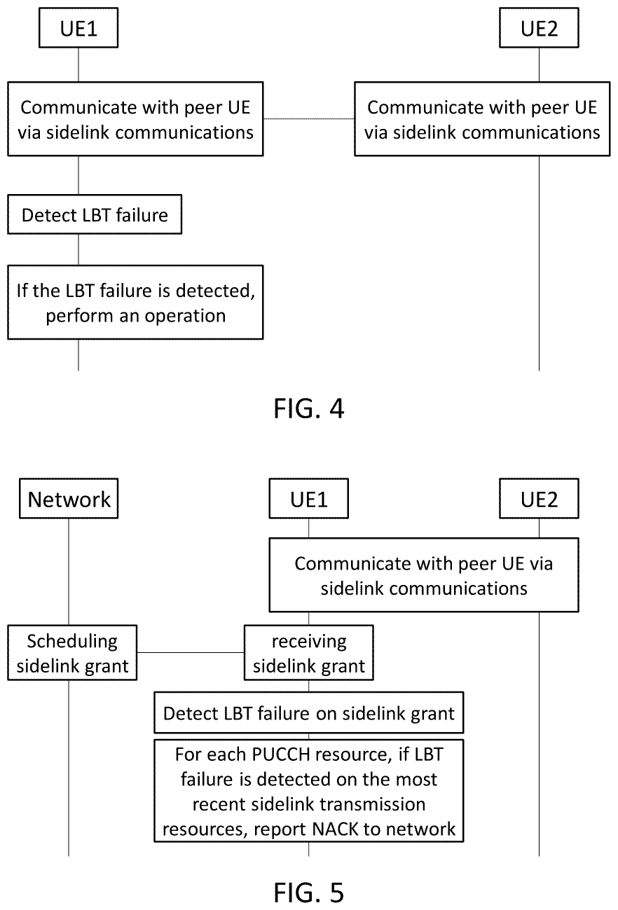

FIG. 4 shows a schematic diagram of a sidelink communication according to an embodiment of the present disclosure. In FIG. 4, the UE1 communication with peer UE (i.e., UE2) via sidelink communications (in an unlicensed spectrum). The UE1 performs a LBT procedure for the sidelink communication and detects whether there is a LBT failure or LCT success. If detecting the LBT failure, the UE1 performs an operation including at least one of:
triggering resource re-selection;
removing the LBT failure resource(s) from the selected sidelink resource;
dropping the LBT failure resource(s) from the selected sidelink resource; or
randomly selecting a resource from the resources indicated by the physical layer and replace the removed or dropped resource(s) by the selected resource(s).

In some embodiments, the Network may schedule more than one sidelink transmission resource via the PDCCH and one HARQ feedback resource on PUCCH may also be configured. When the UE has a sidelink grant and a Uu grant at the same time and the UE cannot perform the sidelink and Uu communications simultaneously, a prioritization procedure may be need for prioritizing one of the sidelink transmission and the Uu transmission (i.e., sidelink data and Uu data) to be transmitted. If the SL transmission is not prioritized, the UE may send the NACK to the network for requesting more transmission resources. In an embodiment, the UE may send the NACK to the network if the most recent transmission resource (configured for the sidelink transmission) is not prioritized.

For example, 3 transmission resources are scheduled by the DCI and associated with the same PUCCH resource and only the third transmission resource is not prioritized, the UE needs to send the NACK to the network, since the third transmission resource is the most recent resource for the PUCCH transmission.

In an embodiment of the sidelink communication is performed on the unlicensed band, it is also possible that the most recent transmission resource cannot be transmitted because the LBT procedure fails on the most recent transmission resource. Under such conditions, the NACK information also needs to be transmitted to the network for requesting more transmission resources.

In an embodiment, if at least one of following condition is met, the UE instructs the physical layer (entities) to signal a NACK on the PUCCH:
1. LBT failure is detected on the most recent transmission resource of the MAC PDU;
2. LBT on the most recent transmission resource of the MAC PDU fails;
3. LBT failure indication is received from lower layers on the most recent transmission resource of the MAC PDU;
4. The most recent transmission resource is not transmitted due to LBT failure; or
5. The most recent transmission resource is not transmitted.

FIG. 5 shows a schematic diagram of a sidelink communication according to an embodiment of the present disclosure. In FIG. 5, the UE1 communicates with peer UE (i.e., UE2) via sidelink communications, e.g., on an unlicensed spectrum. In this embodiment, the UE1 receives a sidelink grant from network and may perform the sidelink communications by using the sidelink grant. The UE1 may perform an LBT procedure on (transmission resources configured by) the sidelink grant, to detect an LBT failure or LBT success. For each PUCCH resource, if detecting the LBT failure on the most recent sidelink transmission resources, the UE1 reports/transmits NACK to the network.

In some embodiments of the UE performing the sidelink communications, the UE transmits the data on a PSSCH (physical sidelink shared channel) and receives a HARQ feedback on a PSFCH (physical sidelink feedback channel). Based on the HARQ feedback on PSFCH, each PSSCH resource is associated with one PSFCH resource. The UE therefore can perform the HARQ-based sidelink RLF (radio link failure) detection, i.e., detecting the sidelink RLF based on the HARQ feedback on the PSFCH resource. Specifically, if the number of consecutive PSFCHs absent reaches the maximum value, the UE considers/determines that the SL RLF is detected.

When the unlicensed band is used as the PSFCH resource, it is possible that the LBT failure is detected on the PSFCH resource. To solve this issue, more than one PSFCH resources associated to one transmission can be configured for the receiving UE to send the HARQ feedback. Thus, how UE performs the HARQ-based SL RLF detection should be specified.

In an embodiment, in response to that the UE is configured with more than one PSFCH reception occasions associated with one PSSCH transmission:
Step 1: If all PSFCH receptions are absent on the PSFCH reception occasions for the PSSCH transmission, increment numConsecutiveDTX (i.e., an integer variable) by 1, otherwise re-initialize/set the numConsecutiveDTX to zero.
Step 2: If the numConsecutiveDTX reaches the maximum value, indicating a HARQ-based Sidelink RLF detection to an RRC layer entity.

The above steps 1 and 2 may be realized by:
1> if all PSFCH reception are absent on the PSFCH reception occasion for the PSSCH transmission:
   2> increment numConsecutiveDTX by 1;
   2> if numConsecutiveDTX reaches the maximum value:
      3> indicate HARQ-based Sidelink RLF detection to RRC.
1> else:
   2> re-initialize numConsecutiveDTX to zero.

In an embodiment, for each PSSCH transmission, the UE performs the following steps:

Step 1: If all the HARQ feedback for this PSSCH transmission is absent, increment numConsecutiveDTX (i.e., an integer variable) by 1, otherwise re-initialize/set the numConsecutiveDTX to zero.

Step 2: If the numConsecutiveDTX reaches the maximum value, indicating a HARQ-based Sidelink RLF detection to an RRC layer entity.

The steps 1 and 2 of this embodiment may be implemented by:
1> If all the HARQ feedback for this PSSCH transmission is absent,
   2> increment numConsecutiveDTX by 1;
   2> if numConsecutiveDTX reaches the maximum value:
      3> indicate HARQ-based Sidelink RLF detection to RRC.
1> else:
   2> re-initialize numConsecutiveDTX to zero.

In an embodiment of the numConsecutiveDTX reaching the maximum value, the UE performs at least one of following:
1. Indicating HARQ-based Sidelink RLF detection to RRC,
2. Considering sidelink radio link failure to be detected for this destination,
3. Releasing the DRBs of this destination,
4. Releasing the SRBs of this destination,
5. Releasing the PC5 Relay RLC channels of this destination,
6. Discarding the NR (new radio) sidelink communication related configuration of this destination,
7. Resetting the sidelink specific MAC of this destination, or
8. Considering the PC5-RRC connection is released for the destination.

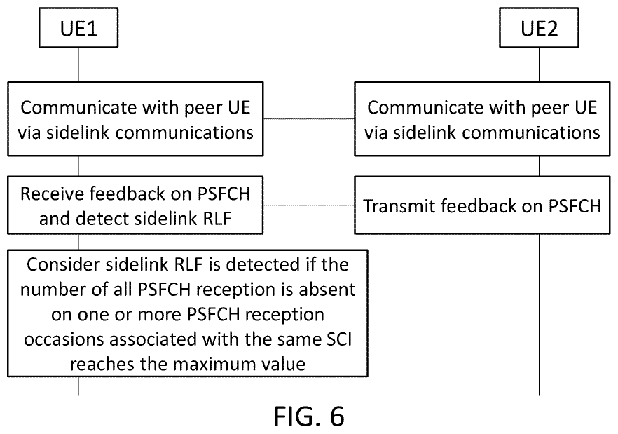

FIG. 6 shows a schematic diagram of a sidelink communication according to an embodiment of the present disclosure. In FIG. 6, the UE1 communication with peer UE (i.e., UE2) via sidelink communications, e.g., on an unlicensed spectrum. In this embodiment, the UE2 transmits feedback on the PSFCH. The UE1 receives the feedback on the PSFCH and detects whether sidelink RLF occurs. The UE1 determines that the sidelink RLF is detected if the number of all PSFCH reception is absent on one or more PSFCH reception occasions associated with the same SCI reaches the maximum value. Note that, this number may be determined based on the above embodiments. In addition, the UE1 may further perform other operations as recited in the above embodiment.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general-purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general-purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

I/We claim:

1. A wireless communication method for use in a first wireless terminal, the method comprising:
receiving, from a second wireless terminal, a sidelink resource indication used for performing a sidelink transmission in an unlicensed carrier after a slot with an index n, and
performing the sidelink transmission in the unlicensed carrier after the slot with the index n based on the sidelink resource indication.

2. The wireless communication method of claim 1, wherein the sidelink resource indication comprises a channel occupancy time sharing indication received at the slot with the index n and a time offset X, and
wherein the sidelink transmission in the unlicensed carrier is performed no earlier than a slot with an index n+X.

3. The wireless communication method of claim 1, wherein the sidelink resource indication comprises a sidelink offset l and a sidelink duration d for the slot n, and
wherein the sidelink transmission in the unlicensed carrier is performed no earlier than a slot with an index n+l+i, where i=0, 1, . . . , d−1.

4. The wireless communication method of claim 1, wherein the sidelink resource is associated with a priority threshold and a sidelink grant, and
wherein a priority value of data in the sidelink transmission is smaller than or equal to the priority threshold for the associated sidelink grant.

5. The wireless communication method of claim 1, wherein the sidelink resource is associated with a destination identifier and a sidelink grant, and
wherein a receiver of the sidelink transmission is associated with the destination identifier for the sidelink grant.

6. The wireless communication method of claim 1, wherein the sidelink resource is associated with a sidelink grant with a priority value; and
in response to the sidelink grant being associated with the priority value, and in response to the first wireless terminal acquiring a sidelink channel access priority for each logical channel, the method further comprising:
selecting the logical channels of which Channel Access Priority Class, CAPC, value is not larger than the priority value; and
performing a sidelink Logical Channel Prioritization procedure.

7. The wireless communication method of claim 1, wherein the sidelink resource is associated with a sidelink grant; and in response to the sidelink grant being associated with a destination identifier, the method further comprising:
selecting the destination identifier associated to the sidelink grant; and
performing a sidelink Logical Channel Prioritization procedure.

8. A wireless communication method for use in a second wireless terminal, the method comprising:
transmitting, to a first wireless terminal, a sidelink resource indication used for allowing the first wireless terminal to perform a sidelink transmission in an unlicensed carrier after a slot with an index n.

9. The wireless communication method of claim 8, wherein the sidelink resource indication comprises a channel occupancy time sharing indication received at the slot with the index n and a time offset X, and
wherein the sidelink transmission in the unlicensed carrier is performed no earlier than a slot with an index n+X.

10. The wireless communication method of claim 8, wherein the sidelink resource indication comprises a sidelink offset l and a sidelink duration d for the slot n, and
wherein the sidelink transmission in the unlicensed carrier is performed no earlier than a slot with an index n+l+i, where i=0, 1, . . . , d−1.

11. The wireless communication method of claim 8, wherein the sidelink resource is associated with a priority threshold and a sidelink grant,
wherein a priority value of data in the sidelink transmission is smaller than or equal to the priority threshold for the associated sidelink grant.

12. The wireless communication method of claim 8, wherein the sidelink resource is associated with a destination identifier and a sidelink grant,
wherein a receiver of the sidelink transmission is associated with the destination identifier for the sidelink grant.

13. A first wireless terminal, comprising:
a communication unit, configured to receive, from a second wireless terminal, a sidelink resource indication used for performing a sidelink transmission in an unlicensed carrier after a slot with an index n, and
at least one processor, configured to perform the sidelink transmission in the unlicensed carrier after the slot with the index n based on the sidelink resource indication.

14. The first wireless terminal of claim 13, wherein the sidelink resource indication comprises a channel occupancy time sharing indication received at the slot with the index n and a time offset X, and
wherein the sidelink transmission in the unlicensed carrier is performed no earlier than a slot with an index n+X.

15. The first wireless terminal of claim 13, wherein the sidelink resource indication comprises a sidelink offset/and a sidelink duration d for the slot n, and
wherein the sidelink transmission in the unlicensed carrier is performed no earlier than a slot with an index n+l+i, where i=0, 1, . . . , d−1.

16. The first wireless terminal of claim 13, wherein the sidelink resource is associated with a priority threshold and a sidelink grant, and
wherein a priority value of data in the sidelink transmission is smaller than or equal to the priority threshold for the associated sidelink grant.

17. The first wireless terminal of claim 13, wherein the sidelink resource is associated with a destination identifier and a sidelink grant, and
wherein a receiver of the sidelink transmission is associated with the destination identifier for the sidelink grant.

18. The first wireless terminal of claim 13, wherein the sidelink resource is associated with a sidelink grant with a priority value; and
the at least one processor is configured to perform, in response to the sidelink grant being associated with the priority value, and in response to the first wireless terminal acquiring a sidelink channel access priority for each logical channel:
selecting the logical channels of which Channel Access Priority Class, CAPC, value is not larger than the priority value; and
performing a sidelink Logical Channel Prioritization procedure.

19. The first wireless terminal of claim 13, wherein the sidelink resource is associated with a sidelink grant with a priority value; and
the at least one processor is configured to perform, in response to the sidelink grant being associated with a destination identifier:
selecting the destination identifier associated to the sidelink grant; and
performing a sidelink Logical Channel Prioritization procedure.
